(19) United States
(12) Patent Application Publication
(10) Pub. No.: US 2022/0198336 A1
(43) Pub. Date: Jun. 23, 2022

(54) Technique for Facilitating Use of Machine Learning Models

(71) Applicant: Telefonaktiebolaget LM Ericsson (publ), Stockholm (SE)

(72) Inventor: Miguel Angel Puente Pestaña, Madrid (ES)

(21) Appl. No.: 17/599,899

(22) PCT Filed: May 15, 2019
(86) PCT No.: PCT/EP2019/062462

§ 371 Date: Sep. 29, 2021

(30) Foreign Application Priority Data
Apr. 3, 2019 (EP) 19382246.7

(51) Int. Cl. G06N 20/00

(52) U.S. Cl. CPC G06N 20/00

(57) ABSTRACT

A technique for facilitating use of machine learning models in a system comprising a plurality of machine learning model providers (802) is disclosed. A method implementation of the technique is performed by a broker component (804) maintaining a provider register containing information about the plurality of machine learning model providers (802) and machine learning models provided by the plurality of machine learning model providers (802). The method comprises receiving a request for a desired machine learning model from a machine learning model consumer (902), determining, based on the information contained in the provider register, a machine learning model among the machine learning models provided by the machine learning model providers (802) that matches the desired machine learning model, and sending a response to the machine learning model consumer (902) providing information associated with the determined machine learning model.

### TECHNICAL FIELD

The present disclosure generally relates to the field of machine learning. In particular, a technique for facilitating use of machine learning models in a system comprising a plurality of machine learning model providers is presented. The technique may be embodied in methods, computer programs, apparatuses and systems.

### BACKGROUND

Mobile communication systems of the fifth generation (5G) generally make use of the so-called Service Based Architecture (SBA) in which, rather than using the traditional peer-to-peer interfaces and protocols, each Network Function (NF) may provide—as a “producer”—one or more “services” to one or more “consumers”. One such producer is the so-called Network Data Analytics Function (NWDAF), which is introduced in 5G systems as a new NF that collects data and provides analytics (e.g., models or patterns) to other NFs, wherein these analytics can be the results of machine learning algorithms executed in the NWDAF. In other words, the NWDAF is assumed to be the NF that hosts the machine learning processes in the mobile communication network for optimization and automation purposes.

As shown in FIG. 1, 5G systems allow any NF to request network analytics information from the NWDAF, wherein the Nnwdaf interface is defined for the consumer NFs (e.g., Policy Control Function (PCF), Network Slice Selection Function (NSSF), etc.) to request subscription to network analytics delivery, to cancel subscription to network analytics delivery, and to request a specific report of network analytics for a particular context. An overview of the service operations supported by the NWDAF via the Nnwdaf interface in accordance with the 3GPP specifications is shown in FIG. 2.

FIG. 3 illustrates an overview of the process of generating machine learning models (e.g., neural networks, support vector machines, etc.) from stored data and providing the models to other NFs by the NWDAF. As shown in the figure, the NWDAF may collect data from a set of NFs and may generate models in a model training phase, wherein the models can then be employed to make predictions based on input data. In one variant, a generated model may be provided to a consumer NF, where it may be employed to make predictions from input data locally. In another variant, the consumer NF may employ the model in a request/response scheme with the NWDAF, wherein the NF provides input data to the NWDAF which uses the model to make predictions and returns the prediction results to the consumer NF. Once trained, each model has particular characteristics, e.g., a certain model accuracy, error statistics, ratio of false positives, etc.

In 5G systems, different NWDAF instances may generally exist in the operator's network and each of them may provide a different set of models for different analytics. In some cases, different NWDAF instances may provide models for the same analytics, but the models may have different characteristics. In order to use a model provided by an NWDAF instance, the consumer NF currently needs follow the discovery mechanisms provided by the Network Repository Function (NRF) to discover the proper NWDAF instance. The use of these discovery mechanisms may be cumbersome, however, and it may thus not be easy for a consumer NF to identify the most appropriate model and NWDAF instance for a desired analytics scenario.

### SUMMARY

Accordingly, there is a need for a technique for facilitating use of machine learning models that avoids one or more of these problems, or other problems.

According to a first aspect, a method for facilitating use of machine learning models in a system comprising a plurality of machine learning model providers is provided. The method is performed by a broker component maintaining a provider register containing information about the plurality of machine learning model providers and machine learning models provided by the plurality of machine learning model providers. The method comprises receiving a request for a desired machine learning model from a machine learning model consumer, determining, based on the information contained in the provider register, a machine learning model among the machine learning models provided by the machine learning model providers that matches the desired machine learning model, and sending a response to the machine learning model consumer providing information associated with the determined machine learning model.

The request may include information characterizing the desired machine learning model, wherein determining the machine learning model that matches the desired machine learning model may include matching the information characterizing the desired machine learning model with the information contained in the provider register. The information characterizing the desired machine learning model may include at least one of an expected output parameter provided by the desired machine learning model, one or more expected input parameters required by the desired machine learning model, an expected type of the desired machine learning model, and one or more evaluation metric based conditions indicative of output characteristics expected to be supported by the desired machine learning model. The information contained in the provider register may include, for each machine learning model provided by one of the plurality of machine learning model providers, at least one of an output parameter provided by the respective machine learning model, one or more input parameters required by the respective machine learning model, a type of the respective machine learning model, and one or more evaluation metric values indicative of output characteristics supported by the respective machine learning model. The information contained in the provider register may include access information for each of the plurality of machine learning model providers. The method may further comprise receiving, prior to receiving the request for the desired machine learning model, a registration message from each of the plurality of machine learning model providers to register its machine learning models with the provider register.

In one variant, the request may be a request to obtain the desired machine learning model for use at the machine learning model consumer. In this case, the information associated with the determined machine learning model provided in the response to the machine learning model consumer may include the determined machine learning model. The method may further comprise sending a request for the determined machine learning model to the machine learning model provider providing the determined machine learning model, and receiving the determined machine learning model from the machine learning model provider providing the determined machine learning model in response to the request.

In another variant, the request may be a request to subscribe for obtaining the desired machine learning model for use at the machine learning model consumer. In this case, the information associated with the determined machine learning model provided in the response to the machine learning model consumer may include a notification on the availability of the determined machine learning model and, optionally, the determined machine learning model. The response including the notification may be sent to the machine learning model consumer conditionally when the determined machine learning model matches the desired machine learning model better than a machine learning model previously sent to the machine learning model consumer as matching the desired machine learning model. The method may further comprise receiving, upon receiving the request for the desired machine learning model, a registration message from a machine learning model provider to register its machine learning models with the provider register, wherein determining the machine learning model that matches the desired machine learning model may include checking the machine learning models registered by the registration message on a match with the desired machine learning model, if a match with the desired machine learning model is determined, sending a request for the determined machine learning model to the machine learning model provider providing the determined machine learning model, and receiving the determined machine learning model from the machine learning model provider providing the determined machine learning model in response to the request.

In a further variant, the request may be a request to use the desired machine learning model, wherein the request may include one or more input values to be passed as input to the desired machine learning model. In this case, the information associated with the determined machine learning model provided in the response to the machine learning model consumer may include an output value output by the determined machine learning model in response to the one or more input values. The method may further comprise sending the one or more input values to the machine learning model provider providing the determined machine learning model as input to the desired machine learning model, and receiving an output value output by the determined machine learning model from the machine learning model provider providing the determined machine learning model in response to the one or more input values.

In a still further variant, the request may be a request to obtain access information to a machine learning model provider providing a machine learning model that matches the desired machine learning model. In this case, the information associated with the determined machine learning model provided in the response to the machine learning model consumer may include access information to the machine learning model provider providing the determined machine learning model.

The system may be a mobile communication system, wherein at least one of the plurality of machine learning model providers may be an NWDAF of the mobile communication system. Also, the system may be a mobile communication system and the broker component may be discoverable by at least one of the machine learning model consumer and the plurality of machine learning model providers via an NRF of the mobile communication system.

According to a second aspect, a method for facilitating use of machine learning models in a system comprising a plurality of machine learning model providers is provided. The method is performed by a machine learning model consumer and comprises sending a request for a desired machine learning model to a broker component maintaining a provider register including information about the plurality of machine learning model providers and machine learning models provided by the plurality of machine learning model providers, and receiving a response from the broker component providing information associated with a machine learning model determined by the broker component among the machine learning models provided by the machine learning model providers as matching the desired machine learning model.

The method according to the second aspect defines a method from a machine learning model consumer's perspective which may be complementary to the method according to the first aspect. As in the method of the first aspect, the request may include information characterizing the desired machine learning model. The information characterizing the desired machine learning model may include at least one of an expected output parameter provided by the desired machine learning model, one or more expected input parameters required by the desired machine learning model, an expected type of the desired machine learning model, and one or more evaluation metric based conditions indicative of output characteristics expected to be supported by the desired machine learning model.

In one variant, the request may be a request to obtain the desired machine learning model for use at the machine learning model consumer. In this case, the information associated with the determined machine learning model provided in the response from the broker component may include the determined machine learning model. In another variant, the request may be a request to subscribe for obtaining the desired machine learning model for use at the machine learning model consumer. In this case, the information associated with the determined machine learning model provided in the response from the broker component may include a notification on the availability of the determined machine learning model and, optionally, the determined machine learning model. In a further variant, the request may be a request to use the desired machine learning model, wherein the request may include one or more input values to be passed as input to the desired machine learning model. In this case, the information associated with the determined machine learning model provided in the response from the broker component may include an output value output by the determined machine learning model in response to the one or more input values.

In a still further variant, the request may be a request to obtain access information to a machine learning model provider providing a machine learning model that matches the desired machine learning model. In this case, the information associated with the determined machine learning model provided in the response from the broker component may include access information to the machine learning model provider providing the determined machine learning model. In one particular such variant, the method may further comprise sending, using the access information, a request for the determined machine learning model to the machine learning model provider providing the determined machine learning model, and receiving the determined machine learning model from the machine learning model provider providing the determined machine learning model in response to the request. In another particular such variant, the method may further comprise sending, to the machine learning model provider providing the determined machine learning model using the access information, a request to subscribe for obtaining the determined machine learning model for use at the machine learning model consumer, and receiving, from the machine learning model provider providing the determined machine learning model, a notification on the availability of the determined machine learning model and, optionally, the determined machine learning model. In a further particular such variant, the method may further comprise sending, to the machine learning model provider providing the determined machine learning model using the access information, a request to use the desired machine learning model, wherein the request may include one or more input values to be passed as input to the desired machine learning model, and receiving, from the machine learning model provider providing the determined machine learning model, an output value output by the determined machine learning model in response to the one or more input values.

The system may be a mobile communication system, wherein at least one of the plurality of machine learning model providers may be an NWDAF of the mobile communication system. Also, the system may be a mobile communication system and the broker component may be discoverable by at least one of the machine learning model consumer and the plurality of machine learning model providers via an NRF of the mobile communication system.

According to a third aspect, a method for facilitating use of machine learning models in a system comprising a plurality of machine learning model providers is provided. The method is performed by a machine learning model provider of the plurality of machine learning model providers and comprises sending, to a broker component maintaining a provider register including information about the plurality of machine learning model providers and machine learning models provided by the plurality of machine learning model providers, the provider register enabling the broker component to determine a machine learning model among the machine learning models provided by the plurality of machine learning model providers that matches a desired machine learning model requested by a machine learning model consumer, a registration message to register machine learning models provided by the machine learning model provider with the provider register of the broker component.

The method according to the third aspect defines a method from a machine learning model provider's perspective which may be complementary to the method according to the first aspect. The registration message may include, for each machine learning model provided by the machine learning model provider, at least one of an output parameter provided by the respective machine learning model, one or more input parameters required by the respective machine learning model, a type of the respective machine learning model, and one or more evaluation metric values indicative of output characteristics supported by the respective machine learning model. The registration message may include access information for the machine learning model provider.

The system may be a mobile communication system, wherein the machine learning model provider may be an NWDAF of the mobile communication system. Also, the system may be a mobile communication system and the broker component may be discoverable by at least one of the machine learning model consumer and the plurality of machine learning model providers via an NRF of the mobile communication system.

According to a fourth aspect, a computer program product is provided. The computer program product comprises program code portions for performing the method of at least one of the first, the second and the third aspect when the computer program product is executed on one or more computing devices (e.g., a processor or a distributed set of processors). The computer program product may be stored on a computer readable recording medium, such as a semiconductor memory, DVD, CD-ROM, and so on.

According to a fifth aspect, a computing unit configured to execute a broker component for facilitating use of machine learning models in a system comprising a plurality of machine learning model providers is provided. The broker component maintains a provider register including information about the plurality of machine learning model providers and machine learning models provided by the plurality of machine learning model providers. The computing unit comprises at least one processor and at least one memory, the at least one memory containing instructions executable by the at least one processor such that the broker component is operable to perform any of the method steps presented herein with respect to the first aspect.

According to a sixth aspect, a computing unit configured to execute a machine learning model consumer for facilitating use of machine learning models in a system comprising a plurality of machine learning model providers is provided. The computing unit comprises at least one processor and at least one memory, the at least one memory containing instructions executable by the at least one processor such that the machine learning model consumer is operable to perform any of the method steps presented herein with respect to the second aspect.

According to a seventh aspect, a computing unit configured to execute a machine learning model provider for facilitating use of machine learning models in a system comprising a plurality of machine learning model providers is provided, wherein the machine learning model provider is one of the plurality of machine learning model providers. The computing unit comprises at least one processor and at least one memory, the at least one memory containing instructions executable by the at least one processor such that the machine learning model provider is operable to perform any of the method steps presented herein with respect to the third aspect.

According to an eighth aspect, there is provided a system comprising a computing unit of the fifth aspect, a computing unit of the sixth aspect, and at least one computing unit of the seventh aspect.

### BRIEF DESCRIPTION OF THE DRAWINGS

Implementations of the technique presented herein are described herein below with reference to the accompanying drawings, in which:

FIG. 1 illustrates the Nnwdaf interface via which any NF may request analytics from an NWDAF;

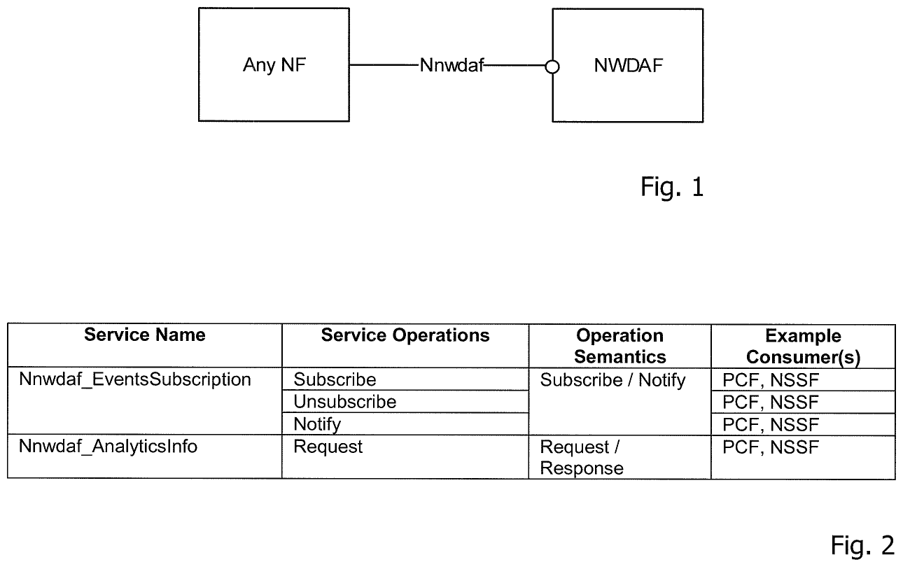

FIG. 2 illustrates an overview of service operations supported by the NWDAF;

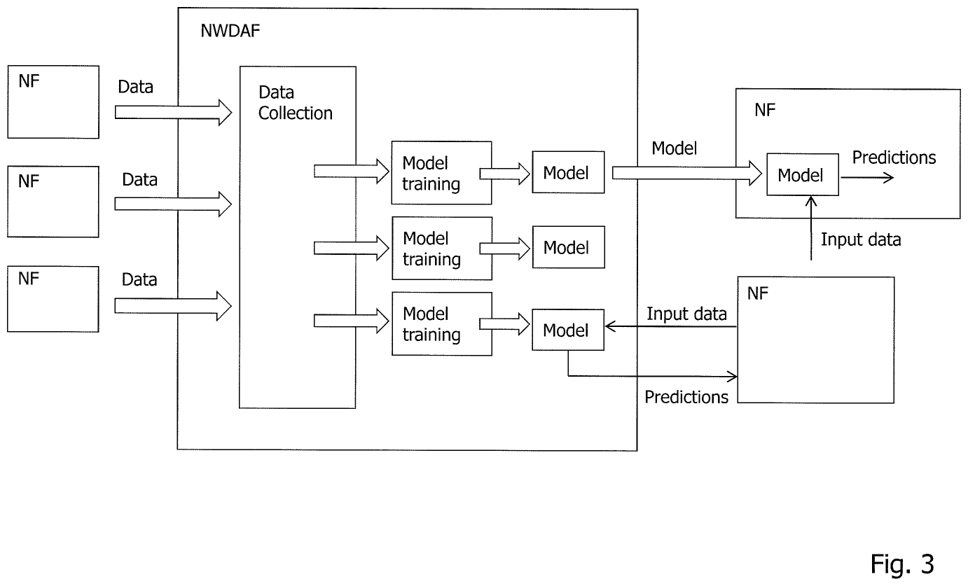

FIG. 3 illustrates an overview of the process of generating machine learning models and providing them to consumer NFs by the NWDAF;

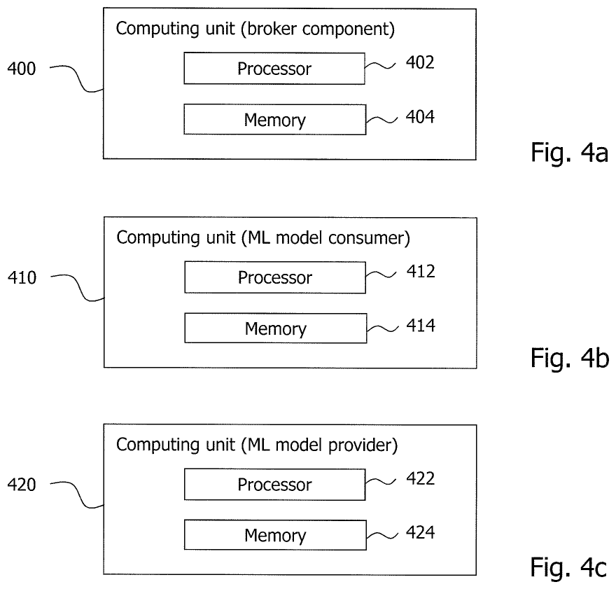

FIGS. 4a to 4c illustrate exemplary compositions of a computing unit configured to execute a broker component, a computing unit configured to execute a machine learning model consumer, and a computing unit configured to execute a machine learning model provider according to the present disclosure;

FIG. 5 illustrates a method which may be performed by the broker component according to the present disclosure;

FIG. 6 illustrates a method which may be performed by the machine learning model consumer according to the present disclosure;

FIG. 7 illustrates a method which may be performed by the machine learning model provider according to the present disclosure;

FIG. 8 illustrates a signaling diagram of an exemplary process in which a machine learning model provider registers with the broker component according to the present disclosure;

FIG. 9 illustrates a signaling diagram of an exemplary process in which a machine learning model consumer obtains a desired machine learning model for use at the machine learning model consumer according to the present disclosure;

FIG. 10 illustrates a signaling diagram of an exemplary process in which a machine learning model consumer subscribes for obtaining a desired machine learning model for use at the machine learning model consumer according to the present disclosure;

FIG. 11 illustrates a signaling diagram of an exemplary process in which a machine learning model consumer uses a desired machine learning model via the broker component according to the present disclosure;

FIGS. 12a and 12b illustrate a signaling diagram of an exemplary process in which a machine learning model consumer obtains access information to a machine learning model provider via the broker component to obtain or use a desired machine learning model directly from the machine learning model provider; and

FIG. 13 illustrates a signaling diagram of an exemplary process in which the broker component registers with an NRF so that the broker component is discoverable by machine learning model consumers and providers according to the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

Those skilled in the art will further appreciate that the steps, services and functions explained herein below may be implemented using individual hardware circuitry, using software functioning in conjunction with a programmed micro-processor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

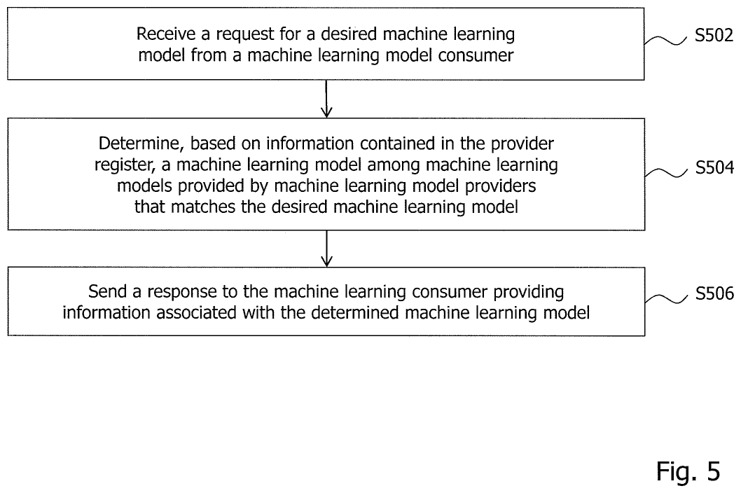

FIG. 4a schematically illustrates an exemplary composition of a computing unit 400 configured to execute a broker component for facilitating use of machine learning models in a system comprising a plurality of machine learning model providers, wherein the broker component maintains a provider register including information about the plurality of machine learning model providers and machine learning models provided by the plurality of machine learning model providers. The computing unit 400 comprises at least one processor 402 and at least one memory 404, wherein the at least one memory 404 contains instructions executable by the at least one processor 402 such that the broker component is operable to carry out the method steps described herein below with reference to the broker component.

FIG. 4b schematically illustrates an exemplary composition of a computing unit 410 configured to execute a machine learning model consumer for facilitating use of machine learning models in a system comprising a plurality of machine learning model providers. The computing unit 410 comprises at least one processor 412 and at least one memory 414, wherein the at least one memory 414 contains instructions executable by the at least one processor 412 such that the machine learning model consumer is operable to carry out the method steps described herein below with reference to the machine learning model consumer.

FIG. 4c schematically illustrates an exemplary composition of a computing unit 420 configured to execute a machine learning model provider for facilitating use of machine learning models in a system comprising a plurality of machine learning model providers, wherein the machine learning model provider is one of the plurality of machine learning model providers. The computing unit 420 comprises at least one processor 422 and at least one memory 424, wherein the at least one memory 424 contains instructions executable by the at least one processor 422 such that the machine learning model provider is operable to carry out the method steps described herein below with reference to the machine learning model provider.

It will be understood that each of the computing unit 400, the computing unit 410 and the computing unit 420 may be implemented on a physical computing unit or a virtualized computing unit, such as a virtual machine, for example. It will further be appreciated that each of the computing unit 400, the computing unit 410 and the computing unit 420 may not necessarily be implemented on a standalone computing unit, but may be implemented as components—realized in software and/or hardware—residing on multiple distributed computing units as well, such as in a cloud computing environment, for example.

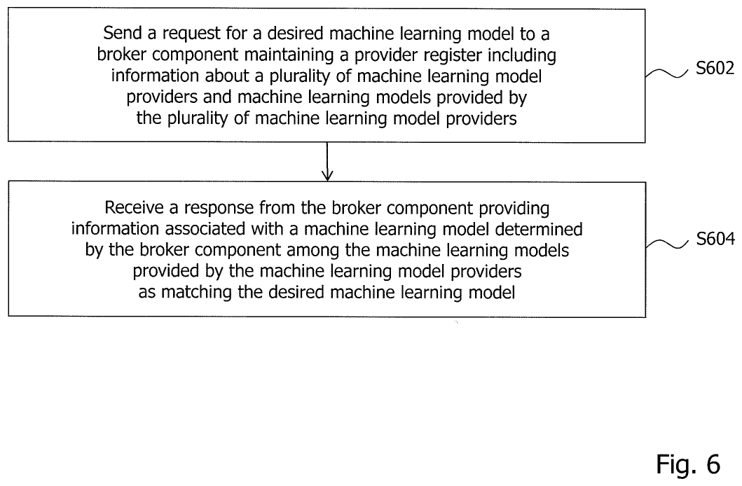

FIG. 5 illustrates a method which may be performed by the broker component executed on the computing unit 400 according to the present disclosure. The method is dedicated to facilitating use of machine learning models in a system comprising a plurality of machine learning model providers, wherein the broker component maintains a provider register containing information about the plurality of machine learning model providers and machine learning models provided by the plurality of machine learning model providers. In step S502, the broker component may receive a request for a desired machine learning model from a machine learning model consumer. In step S504, the broker component may determine, based on the information contained in the provider register, a machine learning model among the machine learning models provided by the machine learning model providers that matches the desired machine learning model. In step S506, the broker component may send a response to the machine learning model consumer providing information associated with the determined machine learning model.

The broker component may thus be used to distribute machine learning models between machine learning model providers and machine learning model consumers. Using the broker component, a machine learning model consumer may obtain access to a machine learning model which meets characteristics required by the machine learning model consumer, i.e., which may be most appropriate for an analytics scenario to be performed by the machine learning model consumer, for example. The machine learning model provider may be any component that stores a machine learning model (e.g., neural network, support vector machine, etc.) and that provides such model for use by machine learning model consumers. The machine learning model may be trained using data collected by the machine learning model provider or data provided to the machine learning model provider by another component. A machine learning model consumer may be any component that uses a machine learning model provided by a machine learning model provider for the purpose of making predictions based on input data passed to the machine learning model. In a 5G system, a machine learning model provider may be an NWDAF and a machine learning model consumer may be an NF which desires to use a machine learning model provided by an NWDAF, for example.

The broker component may determine the most appropriate machine learning model among the machine learning models provided by the machine learning model providers which are registered with the broker component (or, more specifically, with the provider register) by matching the desired machine learning model specified in the request from the machine learning model consumer with the machine learning models registered with the broker component. To this end, the request may include information characterizing the desired machine learning model, wherein determining the machine learning model that matches the desired machine learning model may include matching the information characterizing the desired machine learning model with the information contained in the provider register. To obtain the most appropriate machine learning model, a full match of the information characterizing the desired machine learning model with the information contained in the provider register may be required and, in another variant, a partial match may be sufficient, e.g., when a machine learning model fully matching the information characterizing the desired machine learning model is not available. If plural machine learning models at least partially match the information characterizing the desired machine learning model, the broker component may select the machine learning model which best matches the information characterizing the machine learning model, for example.

The information characterizing the desired machine learning model may include at least one of an expected output parameter (or output parameters) provided by the desired machine learning model, one or more expected input parameters required by the desired machine learning model, an expected type of the desired machine learning model (e.g., a clustering model, a time series model, etc.), and one or more evaluation metric based conditions indicative of output characteristics expected to be supported by the desired machine learning model. Exemplary evaluation metrics may include model accuracy, Mean Squared Error (MSE), F1 score, recall, Receiver Operating Characteristic (ROC) curve Area Under Curve (AUC), confusion matrix parameters (e.g., through-positives, false-negatives, correctness, sensitivity, specificity, etc.), and the like. Conditions defined based on evaluation metrics may be defined based on a single evaluation metric (e.g., model accuracy >0.9, MSE<0.1, etc.) or based on relationships between different evaluation metrics (e.g., combined by mathematical expressions or algorithms).

The information contained in the provider register with which the information characterizing the desired machine learning model is matched may correspond to the same type of information. As such, the information contained in the provider register may include, for each machine learning model provided by one of the plurality of machine learning model providers, at least one of an output parameter (or output parameters) provided by the respective machine learning model, one or more input parameters required by the respective machine learning model, a type of the respective machine learning model, and one or more evaluation metric values indicative of output characteristics supported by the respective machine learning model. To be able to provide access to a machine learning model provider upon request of a machine learning model consumer, the information contained in the provider register may also include access information (e.g., an IP address) for each of the plurality of machine learning providers.

The above information may be comprised in the provider register for every machine learning model of a machine learning model provider that has registered its machine learning models with the provider register. To this end, the broker component may receive, prior to receiving the request for the desired machine learning model, a registration message from each of the plurality of machine learning model providers to register its machine learning models with the provider register, e.g., along with the above-described information characterizing the respective machine learning model as well as the machine learning model provider itself.

A machine learning model consumer may employ the broker component in different ways to make use of a desired machine learning model. For example, the machine learning model consumer may employ the broker component to obtain the desired machine learning model for local use at the machine learning model consumer, to use the desired machine learning model remotely via the broker component (providing input data to the broker component and receiving results from the broker component), or to obtain information to directly access a machine learning model provider providing the desired machine learning model. The information associated with the determined machine learning model which is provided by the broker component in the response to the machine learning model consumer may differ depending on the type of use.

In one such variant, the request received from the machine learning model consumer may be a request to obtain the desired machine learning model for (e.g., local) use at the machine learning model consumer. In this case, the information associated with the determined machine learning model provided in the response to the machine learning model consumer may include the determined machine learning model. In the response to the machine learning model consumer, the determined machine learning model may be sent together with further information characterizing the determined machine learning model, such as the model type and a list of input parameters required by the model. In order to obtain the determined machine learning model for provision to the machine learning model consumer, the broker component may send a request for the determined machine learning model to the machine learning model provider providing the determined machine learning model, and receive the determined machine learning model from the machine learning model provider providing the determined machine learning model in response to the request. The request sent from the broker component to the machine learning model provider may include information specifying the determined machine learning model to be obtained (e.g., the output parameter), and the response sent from the machine learning model provider to the broker component may include information characterizing the determined machine learning model (e.g., the model type and the list of input parameters required by the model).

In another variant, the request received from the machine learning model consumer may be a request to subscribe for obtaining the desired machine learning model for use at the machine learning model consumer. In this case, the information associated with the determined machine learning model provided in the response to the machine learning model consumer may include a notification on the availability of the determined machine learning model and, optionally, the determined machine learning model. In the response, the determined machine learning model may be sent together with further information characterizing the determined machine learning model, such as the model type and a list of input parameters required by the model. At the time of subscription, the broker component may not yet have information about a machine learning model in the provider register which matches the desired machine learning model and may have to wait until a machine learning model provider registers an appropriate machine learning model with the broker component. The broker component may thus receive, upon receiving the request for the desired machine learning model, a registration message from a machine learning model provider to register its machine learning models with the provider register, wherein determining the machine learning model that matches the desired machine learning model may include checking the machine learning models registered by the registration message on a match with the desired machine learning model. If a match with the desired machine learning model is determined, the broker component may send a request for the determined machine learning model to the machine learning model provider providing the determined machine learning model, and receive the determined machine learning model from the machine learning model provider providing the determined machine learning model in response to the request. The request sent from the broker component to the machine learning model provider may include information specifying the determined machine learning model to be obtained (e.g., the output parameter), and the response sent from the machine learning model provider to the broker component may include information characterizing the determined machine learning model (e.g., the model type and the list of input parameters required by the model). In order to avoid sending duplicate machine learning models to the machine learning model consumer within the subscription, e.g., in case another machine learning model provider subsequently registers with the broker component, the broker component may be configured to send the response including the notification to the machine learning model consumer conditionally (e.g., only) when the determined machine learning model matches the desired machine learning model better than a machine learning model previously sent to the machine learning model consumer as matching the desired machine learning model.

In a further variant, the request received from the machine learning model consumer may be a request to use the desired machine learning model, wherein the request may include one or more input values to be passed as input to the desired machine learning model. In this case, the information associated with the determined machine learning model provided in the response to the machine learning model consumer may include an output value output by the determined machine learning model in response to the one or more input values. In order to obtain the output value from the determined machine learning model, the broker component may send the one or more input values to the machine learning model provider providing the determined machine learning model as input to the desired machine learning model, and receive an output value output by the determined machine learning model from the machine learning model provider providing the determined machine learning model in response to the one or more input values. The request sent from the broker component to the machine learning model provider may further include information specifying the machine learning model to be used (e.g., the output parameter).

In a still further variant, the request received from the machine learning model consumer may be a request to obtain access information to a machine learning model provider providing a machine learning model that matches the desired machine learning model. In this case, the information associated with the determined machine learning model provided in the response to the machine learning model consumer may include access information to the machine learning model provider providing the determined machine learning model (e.g., an IP address of the machine learning model provider). The access information may be obtained from the provider register, in which the access information may be stored when the machine learning model provider providing the determined machine learning model registers with the broker component, as described above.

As said, in a 5G system, the machine learning model provider may be an NWDAF and the machine learning model consumer may be an NF which desires to use a machine learning model provided by an NWDAF. The system may thus be a mobile communication system (e.g., a 5G system), wherein at least one of the plurality of machine learning model providers may be a NWDAF of the mobile communication system. In the system, the broker component may be provided as a standalone component or may be executed as a subcomponent of another component, e.g., as a subcomponent of an NRF, an NWDAF, or an NF in general. In order to make the broker component discoverable by other components (e.g., NFs) in the system, in particular in case the broker component is provided as a standalone component (e.g., when the broker component is deployed out of the NRF), the broker component may register itself with the NRF so that it is discoverable by other components using the NRF. In one variant, therefore, the system may be a mobile communication system and the broker component may be discoverable by at least one of the machine learning model consumer and the plurality of machine learning model providers via an NRF of the mobile communication system.

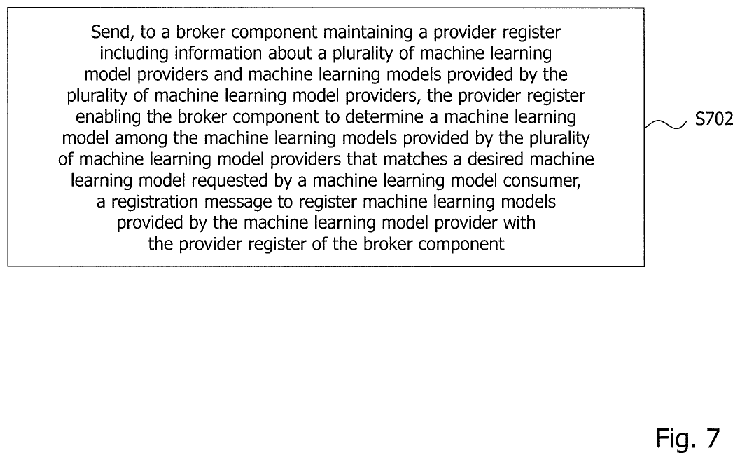

FIG. 6 illustrates a method which may be performed by the machine learning model consumer executed on the computing unit 410 according to the present disclosure. The method is dedicated to facilitating use of machine learning models in a system comprising a plurality of machine learning model providers. The operation of the machine learning model consumer may be complementary to the operation of the broker component described above in relation to FIG. 5 and, as such, aspects described above with regard to the operation of the machine learning model consumer may be applicable to the operation of the machine learning model consumer executed on the computing unit 410 described in the following as well, and vice versa. Unnecessary repetitions are thus omitted in the following.

In step S602, the broker component may send a request for a desired machine learning model to a broker component (e.g., the broker component executed on the computing unit 400) maintaining a provider register including information about the plurality of machine learning model providers and machine learning models provided by the plurality of machine learning model providers. In step S604, the broker component may receive a response from the broker component providing information associated with a machine learning model determined by the broker component among the machine learning models provided by the machine learning model providers as matching the desired machine learning model.

As described above in relation to FIG. 5, the request sent by the machine learning model consumer may include information characterizing the desired machine learning model. The information characterizing the desired machine learning model may include at least one of an expected output parameter provided by the desired machine learning model, one or more expected input parameters required by the desired machine learning model, an expected type of the desired machine learning to model, and one or more evaluation metric based conditions indicative of output characteristics expected to be supported by the desired machine learning model.

In one variant, the request may be a request to obtain the desired machine learning model for use at the machine learning model consumer. In this case, the information associated with the determined machine learning model provided in the response from the broker component may include the determined machine learning model. In another variant, the request may be a request to subscribe for obtaining the desired machine learning model for use at the machine learning model consumer. In this case, the information associated with the determined machine learning model provided in the response from the broker component may include a notification on the availability of the determined machine learning model and, optionally, the determined machine learning model. In a further variant, the request may be a request to use the desired machine learning model, wherein the request may include one or more input values to be passed as input to the desired machine learning model. In this case, the information associated with the determined machine learning model provided in the response from the broker component may include an output value output by the determined machine learning model in response to the one or more input values.

In a still further variant, the request may be a request to obtain access information to a machine learning model provider providing a machine learning model that matches the desired machine learning model. In this case, the information associated with the determined machine learning model provided in the response from the broker component may include access information to the machine learning model provider providing the determined machine learning model. In one particular such variant, the machine learning model consumer may send, using the access information, a request for the determined machine learning model to the machine learning model provider providing the determined machine learning model, and receive the determined machine learning model from the machine learning model provider providing the determined machine learning model in response to the request. The request sent from the machine learning model consumer to the machine learning model provider may include information specifying the determined machine learning model to be obtained (e.g., the output parameter), and the response sent from the machine learning model provider to the machine learning model consumer may include information characterizing the determined machine learning model (e.g., the model type and the list of input parameters required by the model).

In another such variant, the machine learning model consumer may send, to the machine learning model provider providing the determined machine learning model using the access information, a request to subscribe for obtaining the determined machine learning model for use at the machine learning model consumer, and receive, from the machine learning model provider providing the determined machine learning model, a notification on the availability of the determined machine learning model and, optionally, the determined machine learning model. In the notification, the determined machine learning model may be sent together with further information characterizing the determined machine learning model, such as the model type and a list of input parameters required by the model. The request to subscribe for obtaining the determined machine learning model may comprise the same information characterizing the desired machine learning model which has already be sent in the previous request to the machine learning model consumer, and the machine learning model provider may send the notification as soon and a new machine learning model is available at the machine learning provider that matches the desired machine learning model.

In a further such variant, the machine learning model consumer may send, to the machine learning model provider providing the determined machine learning model using the access information, a request to use the desired machine learning model, wherein the request may include one or more input values to be passed as input to the desired machine learning model, and receive, from the machine learning model provider providing the determined machine learning model, an output value output by the determined machine learning model in response to the one or more input values. The request sent from the machine learning model consumer to the machine learning model provider may further include information specifying that determined machine learning model to be used (e.g., the output parameter).

As described above in relation to FIG. 5, the system may be a mobile communication system, wherein at least one of the plurality of machine learning model providers may be an NWDAF of the mobile communication system. Also, the system may be a mobile communication system and the broker component may be discoverable by at least one of the machine learning model consumer and the plurality of machine learning model providers via an NRF of the mobile communication system.

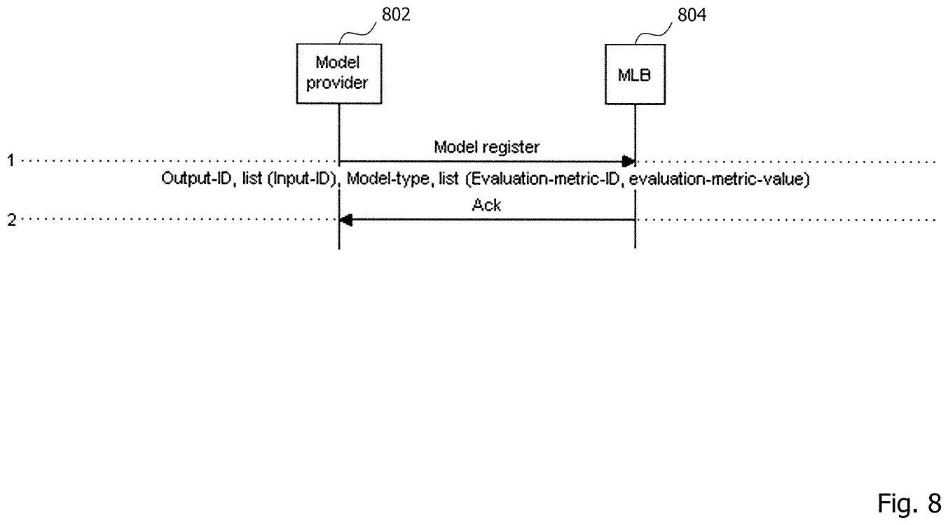

FIG. 7 illustrates a method which may be performed by the machine learning model provider executed on the computing unit 420 according to the present disclosure. The method is dedicated to facilitating use of machine learning models in a system comprising a plurality of machine learning model providers, wherein the machine learning model provider is one of the plurality of machine learning model providers. The operation of the machine learning model provider may be complementary to the operation of the broker component described above in relation to FIG. 5 and, as such, aspects described above with regard to the operation of the machine learning model provider may be applicable to the operation of the machine learning model provider described in the following as well, and vice versa. Unnecessary repetitions are thus omitted in the following.

In step S702, the machine learning model provider may send, to a broker component (e.g., to the broker component executed on computing unit 400) maintaining a provider register including information about the plurality of machine learning model providers and machine learning models provided by the plurality of machine learning model providers, the provider register enabling the broker component to determine a machine learning model among the machine learning models provided by the plurality of machine learning model providers that matches a desired machine learning model requested by a machine learning model consumer, a registration message to register machine learning models provided by the machine learning model provider with the provider register of the broker component.

As described above in relation to FIG. 5, the registration message may include, for each machine learning model provided by the machine learning model provider, at least one of an output parameter provided by the respective machine learning model, one or more input parameters required by the respective machine learning model, a type of the respective machine learning model, and one or more evaluation metric values indicative of output characteristics supported by the respective machine learning model. The registration message may include access information for the machine learning model provider. The system may be a mobile communication system, wherein the machine learning model provider may be an NWDAF of the mobile communication system. Also, the system may be a mobile communication system and the broker component may be discoverable by at least one of the machine learning model consumer and the plurality of machine learning model providers via an NRF of the mobile communication system.

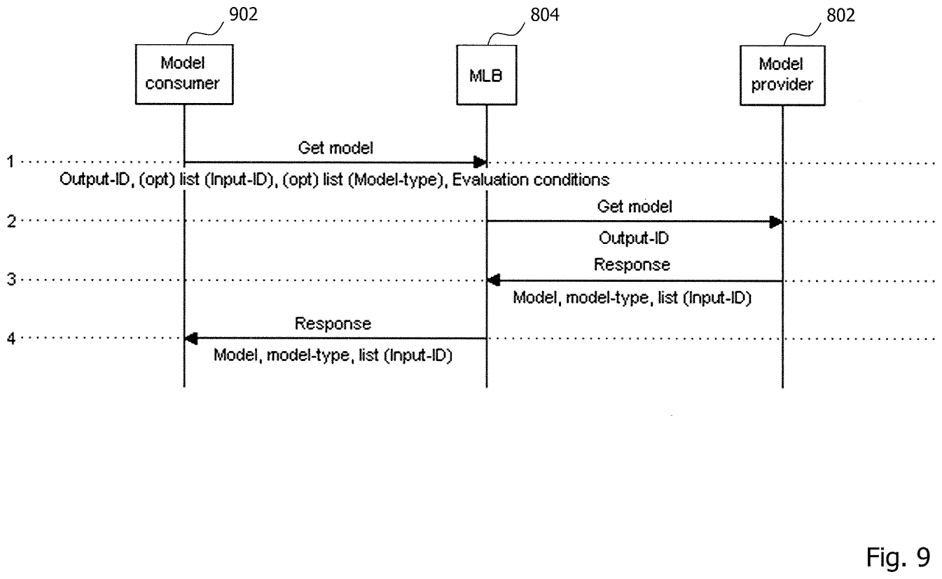

FIG. 8 illustrates a signaling diagram of an exemplary process in which a machine learning model provider 802 registers with a broker component 804 (denoted “machine learning broker” (MLB) in the figure) according to the present disclosure. In step 1 of the process, the machine learning model provider 802 may send a registration message to the broker component 804 to register a machine learning model with the broker component 804. The registration message may include an identification of an output parameter provided by the machine learning model, a list of identifications of input parameters required by the machine learning model, an indication of the type of the machine learning model, and a list of tuples each including an identification of an evaluation metric and a corresponding elevation metric value. In step 2, the broker component 804 may respond with an acknowledgment for the registration.

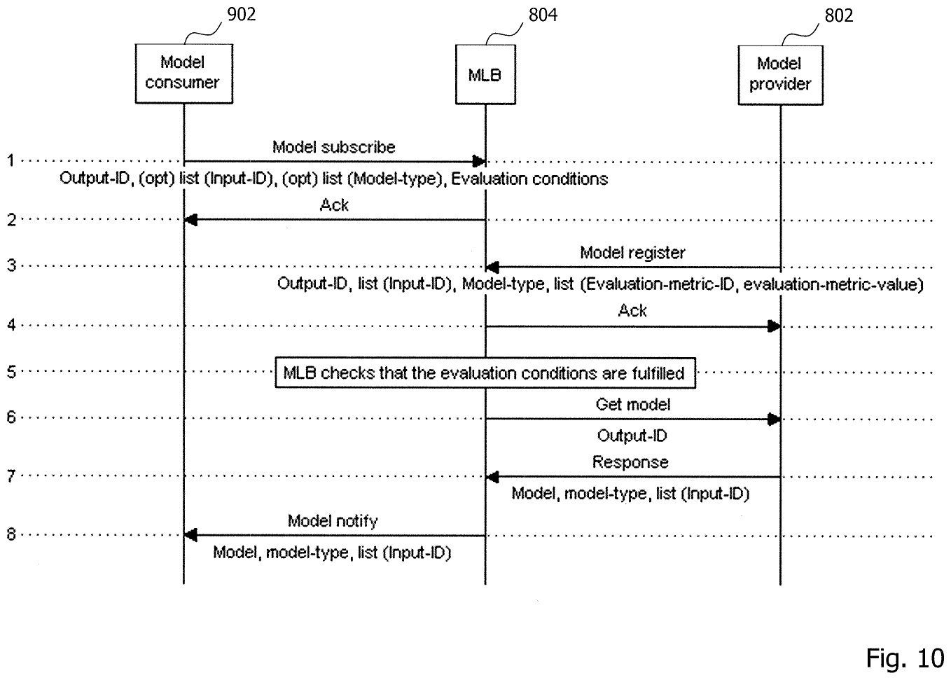

FIG. 9 illustrates a signaling diagram of an exemplary process in which a machine learning model consumer 902 obtains a desired machine learning model for use at the machine learning model consumer 902 from the machine learning model provider 802 via the broker component 804 according to the present disclosure. In step 1 of the process, the machine learning model consumer 902 may send a “get model” message to the broker component 804, wherein the message may include an identification of an expected output parameter provided by the machine learning model, a list of identifications of expected input parameters required by the machine learning model, a list of indications of expected types of the machine learning model (e.g., model types supported by the machine learning model consumer 902), and evaluation conditions indicative of output characteristics expected to be supported by the machine learning model. In step 2, the broker component 804 may check the matching machine learning models using the information contained in the provider register and send a “get model” message including the identification of the output parameter to the machine learning model provider 802 providing the determined machine learning model. In step 3, the machine learning model provider 802 may respond to the broker component 804 together with the machine learning model, the model type and a list of identifications of input parameters required by the model. In step 4, the broker component 804 may respond to the machine learning model consumer 902 together with the machine learning model, the model type and the list of identifications of input parameters required by the model accordingly.

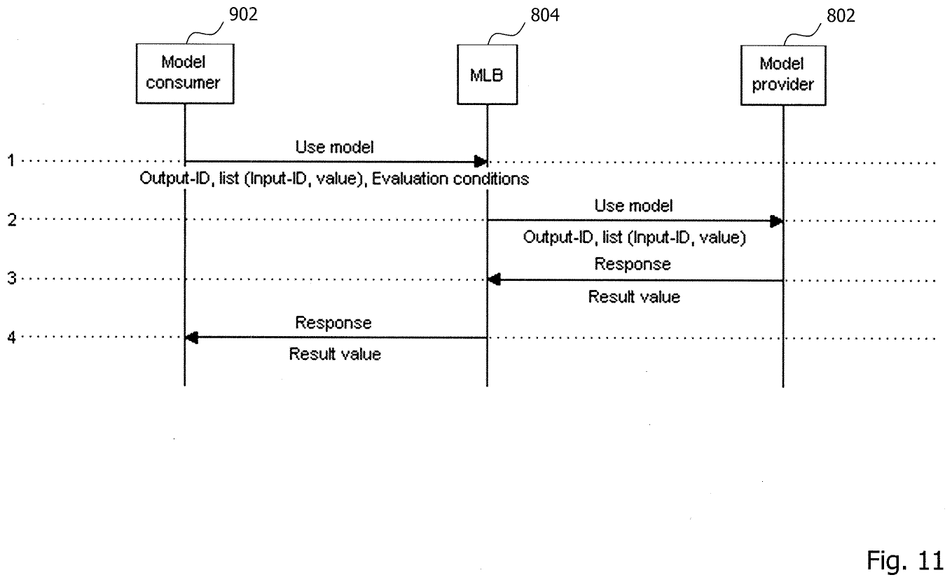

FIG. 10 illustrates a signaling diagram of an exemplary process in which the machine learning model consumer 902 subscribes for obtaining the desired machine learning model for use at the machine learning model consumer 902 according to the present disclosure. In step 1 of the process, the machine learning model consumer 902 may send a “model subscribe” message to the broker component 804, wherein the message may include an identification of an expected output parameter provided by the machine learning model, a list of identifications of expected input parameters required by the machine learning model, a list of indications of expected types of the machine learning model (e.g., model types supported by the machine learning model consumer 902), and evaluation conditions indicative of output characteristics expected to be supported by the machine learning model. In step 2, the broker component 804 may respond with an acknowledgment for the subscription. At this time, the broker component 804 may not yet have information about a machine learning model in the provider register which matches the desired machine learning model and the broker component 804 may therefore wait until a machine learning provider registers an appropriate machine learning model with the broker component 804. In step 3, such registration may take place and, therefore, the learning machine model provider 802 may register a new machine learning model with the broker component 804 (e.g., following the procedure described above in relation to FIG. 8). In step 4, the broker component 804 may respond with an acknowledgment for the registration. In step 5, the broker component 804 may check whether the new machine learning model fulfills the evaluation conditions desired by the machine learning model consumer 902. If the broker component 804 has already provided a machine learning model to the machine learning model consumer 902 previously, the broker component 804 may check whether the new model better fulfills the conditions as compared to the model previously provided to the machine learning model consumer 902 and, if the new model does not improve the old model, the new model may not be provided to the machine learning model consumer 902. Otherwise, or if a machine learning model has not been provided to the machine learning model consumer 902 previously, the broker component 804 may, in step 6, send a “get model” message to the machine learning model provider 802 including the identification of the output parameter. In step 7, the machine learning model provider 802 may respond to the broker component 804 together with the machine learning model, the model type and a list of identifications of input parameters required by the model. In step 8, the broker component 804 may send a notification to the machine learning model consumer 902 together with the machine learning model, the model type and the list of identifications of input parameters required by the model accordingly.

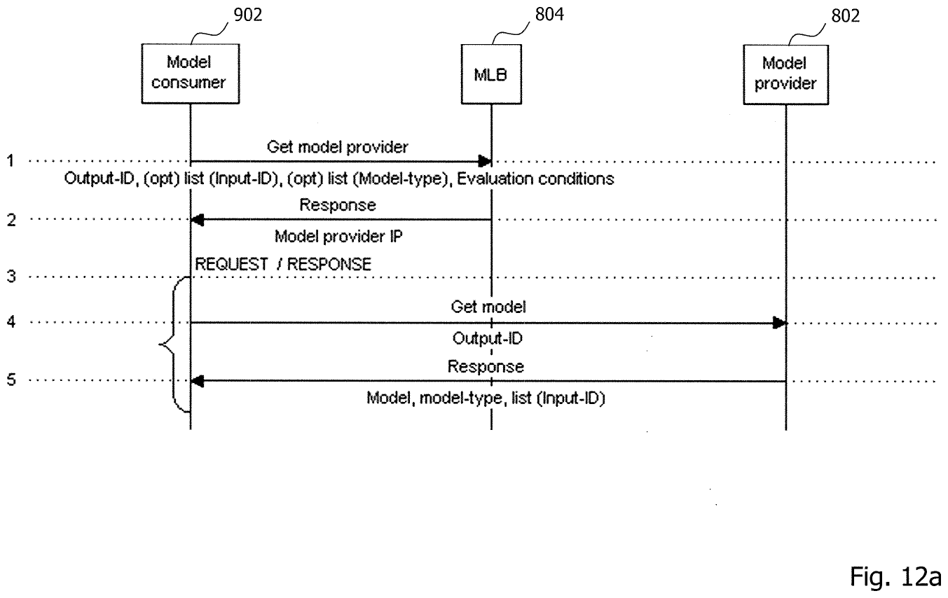

FIG. 11 illustrates a signaling diagram of an exemplary process in which the machine learning model consumer 902 uses the desired machine learning model via the broker component 804 according to the present disclosure. In step 1 of the process, the machine learning model consumer 902 may send a “use model” message to the broker component 804, wherein the message may include an identification of the expected output parameter provided by the machine learning model, a list of tuples each including an identification of an input parameter together with a corresponding input value (i.e., representing the input for the machine learning model including input parameters and values), and evaluation conditions indicative of output characteristics expected to be supported by the machine learning model. In step 2, the broker component 804 may check the matching machine learning models using the information contained in the provider register and send a “use model” message to the machine learning model provider 802 including the identification of the output parameter and the list of tuples representing the input for the machine learning model. In step 3, the machine learning model provider 802 may pass the input to the machine learning model and execute the machine learning model to obtain a result value representing the output from the machine learning model and, once available, the machine learning model provider 802 may respond to the broker component 804 with the result value. In step 4, the broker component 804 may forward the result value to the machine learning model consumer 902 accordingly.

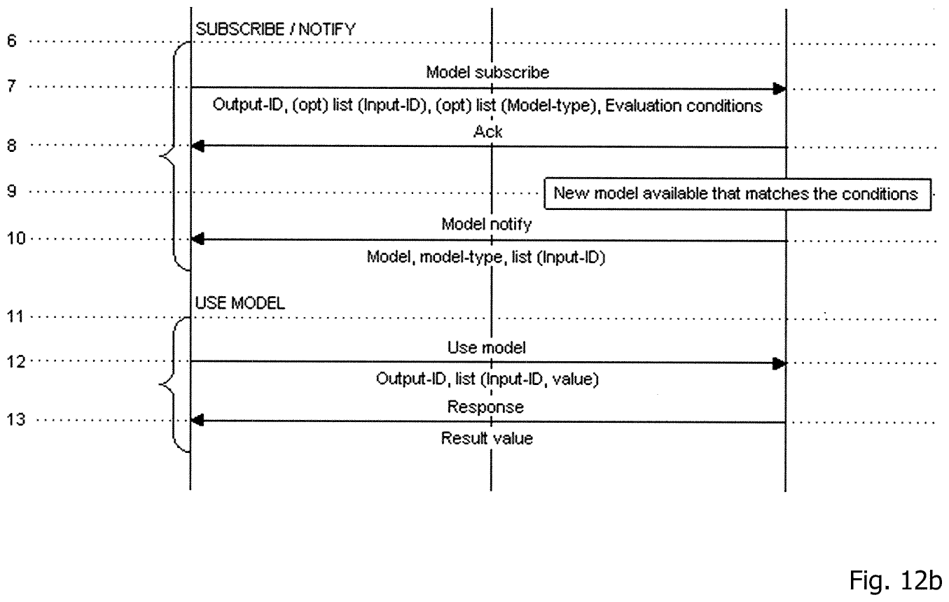

FIGS. 12a and 12b illustrate a signaling diagram of an exemplary process in which the machine learning model consumer 902 obtains access information to the machine learning model provider 802 from the broker component 804 to obtain (or use) the desired machine learning model directly from the machine learning model provider 802 according to the present disclosure. In step 1 of the process, the machine learning model consumer 902 may send a “get model provider” message to the broker component 804, wherein the message may include an identification of an expected output parameter provided by the machine learning model, a list of identifications of expected input parameters required by the machine learning model, a list of indications of expected types of the machine learning model (e.g., model types supported by the machine learning model consumer 902), and evaluation conditions indicative of output characteristics expected to be supported by the machine learning model. In step 2, the broker component may check the matching machine learning models using the information contained in the provider register and respond to the machine learning model consumer 902 with the IP address of the machine learning model provider 802 providing the desired machine learning model. Alternatively, the broker component 804 may provide a list of matching machine learning model providers and the model consumer 902 may decide which model provider to use. Upon receipt of the IP address, the machine learning model consumer 902 may have different options to obtain or use the desired machine learning model. The first option is indicated in steps 3 to 5, wherein the machine learning model consumer 902 sends a “get model” message to the machine learning model provider 802 including the indication of the output parameter, and the machine learning model provider 802 responds together with the machine learning model, the model type and a list of identifications of input parameters required by the model. The second option is indicated in steps 6 to 10 (shown in FIG. 12b), wherein the machine learning model consumer 902 sends a “model subscribe” message to the machine learning model consumer 902 (including an identification of an expected output parameter provided by the machine learning model, a list of identifications of expected input parameters required by the machine learning model, a list of indications of expected types of the machine learning model, e.g., model types supported by the machine learning model consumer 902, and evaluation conditions indicative of output characteristics expected to be supported by the machine learning model), and wherein the machine learning model provider 802 responds with an acknowledgment for the subscription and sends a notification, once a new machine learning model is available that matches the conditions, to the machine learning model consumer 902 including the new machine learning model together with the model type and a list of identifications of input parameters required by the model. The third option is indicated in steps 11 to 13, wherein the machine learning model consumer 902 sends a “use model” message to the machine learning model provider 802 including the identification of the output parameter provided by the machine learning model as well as a list of tuples each including an identification of an input parameter together with a corresponding input value (i.e., representing the input for the machine learning model including input parameters and values), and wherein the machine learning model provider 802 responds, upon execution of the machine learning model based on the provided input, with the corresponding result value output by the machine learning model.

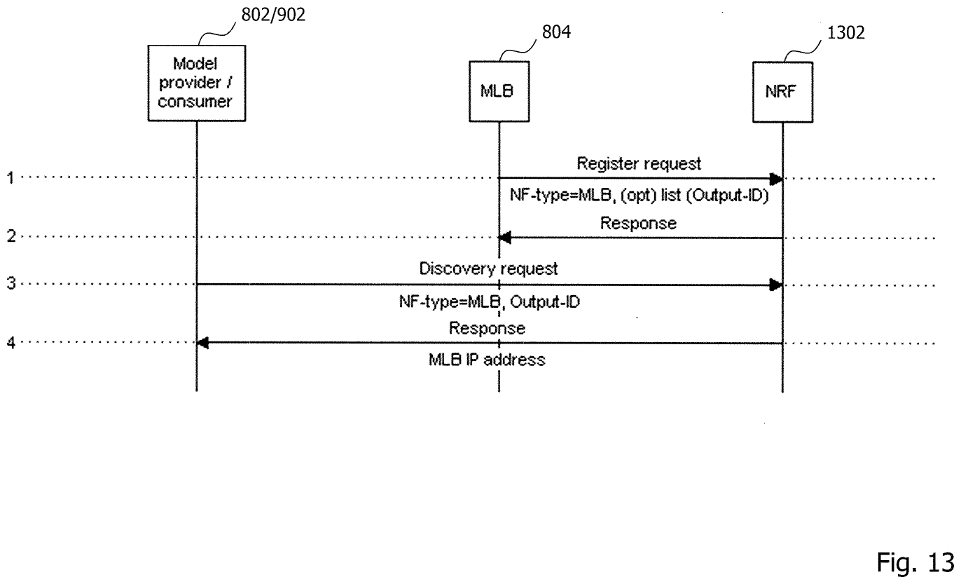

FIG. 13 illustrates a signaling diagram of an exemplary process in which the broker component 804 registers with an NRF 1302 so that the broker component 804 is discoverable by machine learning model consumers and providers 802, 902 according to the present disclosure. In step 1 of the process, the broker component 804 may send a registration request to the NRF 1302, wherein the request may include an indication of the type of the NF to be registered (which, in this case, equals to “MLB”) and, optionally, a list of identifications of output parameters which the broker component 804 supports (which may be expedient if there are different broker components supporting different output parameters). In step 2, the NRF 1302 may respond with an acknowledgment of the registration request. Subsequently, the broker component 804 may be discoverable by machine learning model providers and consumers 802, 902 via the NRF 1302. Therefore, when a machine learning model provider or consumer 802, 902 wants to discover the broker component 804 to register or get/use a machine learning model, respectively, the machine learning model provider or consumer 802, 902 may send, in step 3, a discovery request to the NRF 1302, wherein the request may include an indication of the type of NF to be discovered (which, in this case, equals to “MLB”) and an indication of the output parameter of the machine learning model which the machine learning model provider or consumer 802, 902 wishes to register or get/use, respectively. In step 4, the NRF 1302 may respond to the machine learning model provider or consumer 802, 902 together with the IP address of the broker component 804 to thereby enable the machine learning model provider or consumer 802, 902 to access the broker component 804.

As has become apparent from the above, the present disclosure provides a technique for facilitating use of machine learning models in a system comprising a plurality of machine learning model providers. The presented technique may generally be based on a machine learning broker which registers model providers and the models they produce, wherein model consumers may query the broker for a desired model. The technique may thus enable dynamic provision and consumption of machine learning models. In particular, the technique may allow model consumers to get models from different model providers, wherein model consumers may specify what characteristics the desired model should have. The broker may act as proxy so that model consumers may not be aware of the model providers. In some variants, the broker may provide the models directly to the consumers while, in other variants, the broker may route the model usage requests along with the input parameters to the model provider and provide the results back to the model consumer. Using the technique presented herein, it may also be conceivable that the broker distributes model requests between different model providers following a certain distribution (e.g., evenly, based on the model provider resources, etc.), such as for load balancing purposes, for example.

It is believed that the advantages of the technique presented herein will be fully understood from the foregoing description, and it will be apparent that various changes may be made in the form, constructions and arrangement of the exemplary aspects thereof without departing from the scope of the invention or without sacrificing all of its advantageous effects. Because the technique presented herein can be varied in many ways, it will be recognized that the invention should be limited only by the scope of the claims that follow.

1-47. (canceled)

48. A method for facilitating use of machine learning models in a system comprising a plurality of machine learning model providers, the method being performed by a broker component maintaining a provider register containing information about the plurality of machine learning model providers and machine learning models provided by the plurality of machine learning model providers, the method comprising:
receiving a request for a desired machine learning model from a machine learning model consumer;
determining, based on the information contained in the provider register, a machine learning model among the machine learning models provided by the machine learning model providers that matches the desired machine learning model; and
sending a response to the machine learning model consumer providing information associated with the determined machine learning model.

49. The method of claim 48, wherein the request includes information characterizing the desired machine learning model and wherein determining the machine learning model that matches the desired machine learning model includes matching the information characterizing the desired machine learning model with the information contained in the provider register.

50. The method of claim 49, wherein the information characterizing the desired machine learning model includes at least one of:
an expected output parameter provided by the desired machine learning model,
one or more expected input parameters required by the desired machine learning model,
an expected type of the desired machine learning model, and
one or more evaluation metric-based conditions indicative of output characteristics expected to be supported by the desired machine learning model.

51. The method of claim 48, wherein the information contained in the provider register includes, for each machine learning model provided by one of the plurality of machine learning model providers, at least one of:
an output parameter provided by the respective machine learning model,
one or more input parameters required by the respective machine learning model,
a type of the respective machine learning model, and
one or more evaluation metric values indicative of output characteristics supported by the respective machine learning model.

52. The method of claim 48, wherein the request is a request to subscribe for obtaining the desired machine learning model for use at the machine learning model consumer, and wherein the information associated with the determined machine learning model provided in the response to the machine learning model consumer includes a notification on the availability of the determined machine learning model and wherein the response including the notification is sent to the machine learning model consumer conditionally when the determined machine learning model matches the desired machine learning model better than a machine learning model previously sent to the machine learning model consumer as matching the desired machine learning model.

53. The method of claim 52, further comprising:
receiving, upon receiving the request for the desired machine learning model, a registration message from a machine learning model provider to register its machine learning models with the provider register, wherein determining the machine learning model that matches the desired machine learning model includes checking the machine learning models registered by the registration message on a match with the desired machine learning model;
if a match with the desired machine learning model is determined, sending a request for the determined machine learning model to the machine learning model provider providing the determined machine learning model; and
receiving the determined machine learning model from the machine learning model provider providing the determined machine learning model in response to the request.

54. The method of claim 48, wherein the request is a request to use the desired machine learning model and wherein the request includes one or more input values to be passed as input to the desired machine learning model, and wherein the information associated with the determined machine learning model provided in the response to the machine learning model consumer includes an output value output by the determined machine learning model in response to the one or more input values.

55. The method of claim 54, further comprising:
sending the one or more input values to the machine learning model provider providing the determined machine learning model as input to the desired machine learning model; and
receiving an output value output by the determined machine learning model from the machine learning model provider providing the determined machine learning model in response to the one or more input values.

56. The method of claim 48, wherein the request is a request to obtain access information to a machine learning model provider providing a machine learning model that matches the desired machine learning model and wherein the information associated with the determined machine learning model provided in the response to the machine learning model consumer includes access information to the machine learning model provider providing the determined machine learning model.

57. The method of claim 48, wherein the system is a mobile communication system and the broker component is discoverable by at least one of the machine learning model consumer and the plurality of machine learning model providers via a network repository function (NRF) of the mobile communication system.

58. A method for facilitating use of machine learning models in a system comprising a plurality of machine learning model providers, the method being performed by a machine learning model consumer and comprising:
sending a request for a desired machine learning model to a broker component maintaining a provider register including information about the plurality of machine learning model providers and machine learning models provided by the plurality of machine learning model providers; and
receiving a response from the broker component providing information associated with a machine learning model determined by the broker component among the machine learning models provided by the machine learning model providers as matching the desired machine learning model.

59. The method of claim 58, wherein the request includes information characterizing the desired machine learning model the information characterizing the desired machine learning model including at least one of:
an expected output parameter provided by the desired machine learning model,
one or more expected input parameters required by the desired machine learning model,
an expected type of the desired machine learning model, and
one or more evaluation metric-based conditions indicative of output characteristics expected to be supported by the desired machine learning model.

60. The method of claim 58, wherein the request is a request to subscribe for obtaining the desired machine learning model for use at the machine learning model consumer, and wherein the information associated with the determined machine learning model provided in the response from the broker component includes a notification on the availability of the determined machine learning model and, optionally, the determined machine learning model.

61. The method of claim 58, wherein the request is a request to use the desired machine learning model and wherein the request includes one or more input values to be passed as input to the desired machine learning model.

62. The method of claim 58, wherein the request is a request to obtain access information to a machine learning model provider providing a machine learning model that matches the desired machine learning model, and wherein the information associated with the determined machine learning model provided in the response from the broker component includes access information to the machine learning model provider providing the determined machine learning model.

63. The method of claim 62, further comprising:
sending, to the machine learning model provider providing the determined machine learning model using the access information, a request to use the desired machine learning model, wherein the request includes one or more input values to be passed as input to the desired machine learning model; and
receiving, from the machine learning model provider providing the determined machine learning model, an output value output by the determined machine learning model in response to the one or more input values.

64. The method of claim 58, wherein the system is a mobile communication system and the broker component is discoverable by at least one of the machine learning model consumer and the plurality of machine learning model providers via a network repository function (NRF) of the mobile communication system.

65. A method for facilitating use of machine learning models in a system comprising a plurality of machine learning model providers, the method being performed by a machine learning model provider of the plurality of machine learning model providers and comprising:
sending, to a broker component maintaining a provider register including information about the plurality of machine learning model providers and machine learning models provided by the plurality of machine learning model providers, the provider register enabling the broker component to determine a machine learning model among the machine learning models provided by the plurality of machine learning model providers that matches a desired machine learning model requested by a machine learning model consumer, a registration message to register machine learning models provided by the machine learning model provider with the provider register of the broker component.

66. The method of claim 65, wherein the registration message includes, for each machine learning model provided by the machine learning model provider, at least one of:
an output parameter provided by the respective machine learning model,
one or more input parameters required by the respective machine learning model,
a type of the respective machine learning model, and
one or more evaluation metric values indicative of output characteristics supported by the respective machine learning model.

67. The method of claim 65, wherein the system is a mobile communication system and the broker component is discoverable by at least one of the machine learning model consumer and the plurality of machine learning model providers via a network repository function (NRF) of the mobile communication system.
